(19) United States
(12) Patent Application Publication
(10) Pub. No.: US 2012/0267038 A1
(43) Pub. Date: Oct. 25, 2012

(54) RUBBER STRIP MATERIAL EXTRUSION METHOD

(75) Inventors: Shigeo Kudo, Osaka (JP); Osamu Fujiki, Osaka (JP); Masami Tanabe, Osaka (JP)

(73) Assignee: TOYO TIRE & RUBBER CO., LTD., Osaka (JP)

(21) Appl. No.: 13/525,452

(22) Filed: Jun. 18, 2012

Related U.S. Application Data
(62) Division of application No. 12/675,928, filed on Mar. 1, 2010.

(51) Int. Cl. B29D 30/16

(52) U.S. Cl. 156/117

(57) ABSTRACT

An object is to extrude stably a rubber strip material of a predetermined cross-sectional shape without reducing an extruding speed of the rubber strip material from an extruding die. An extrusion method is provided for the rubber strip material which is used in a tire fabrication process in which an unvulcanized rubber strip material which is extruded from an extruding die of an extruding machine is wound spirally to build a tire rubber member, such that a pair of rotatable rolls are provided at a distal end portion of the extruding die in such a manner that their outer circumferential surfaces confront each other, and in that a rubber material is extruded continuously into a ribbon shape from a gap defined by the pair of confronting rolls.

### CROSS-REFERENCE OF RELATED APPLICATIONS

This application is a Divisional of application Ser. No. 12/675, 928, filed Mar. 1, 2010, which is a 371 of International Application No. PCT/JP2007/068068, filed Sep. 18, 2007.

### TECHNICAL FIELD

The present invention relates to an apparatus and method for extruding a rubber strip material which is used in fabrication of a tire.

### BACKGROUND ART

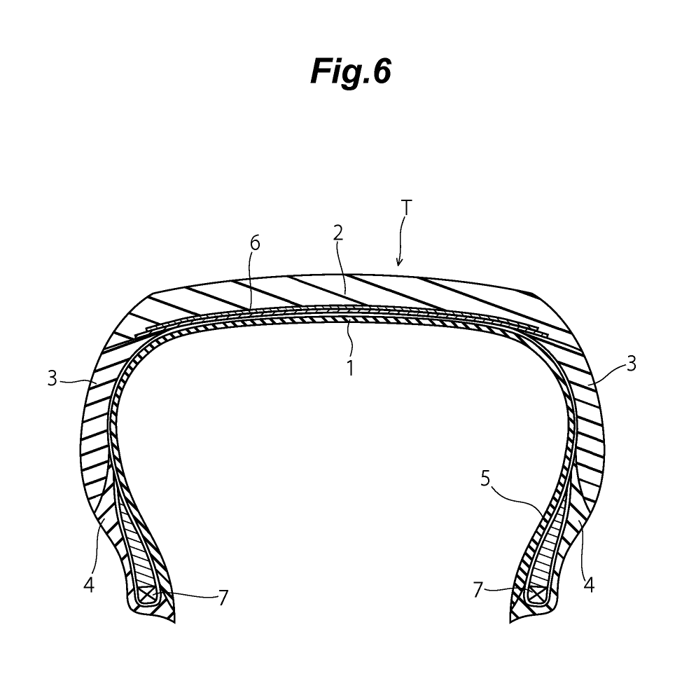

In general, tires are configured in such a manner as to include a plurality of tire rubber members and a plurality of reinforcement members which are mainly made up of cords. In a representative tire, as is shown in FIG. 6, respective portions such as an inner liner rubber portion 1, a tread rubber portion 2, side wall rubber portions 3, rim strip rubber portions 4 and the like are formed by rubber members which match properties required for the respective portions and these rubber members are combined with a carcass layer 5 which constitutes a cord-contained reinforcement member, a belt layer 6 and bead elements 7 to thereby make up a tire T1.

To mold rubber members which make up the respective portions, rubber materials were extruded continuously to be molded into rubber strips from an extrusion apparatus via dies which match cross-sectional shapes of the respective rubber members, and thereafter, the rubber strips so molded were cut to constant dimensions to thereby obtain target rubber members. In building a tire, the rubber members were sequentially affixed together on a rotational support element such as a building drum.

However, due to a problem that a rubber strip member distorts or contracts by the rubber strip member being extruded continuously and molded by the extrusion apparatus and cut to a fixed dimension, as is disclosed in Patent Document No. 1 below, a non-vulcanized rubber strip material which has been extruded and molded into a ribbon shape is wound in an overlapping fashion in a tire circumferential direction on a rotational support element such as a building drum to thereby form a rubber member having a predetermined cross-sectional shape.

In this building operation of a rubber member, in order to eliminate irregularities or difference in level which would be produced in a resultant rubber member when the rubber strip material is wound in a partially overlapping fashion, the cross-sectional shape of the rubber strip material adopts cross-sectional shapes such as a substantially crescent shape, a substantially triangular shape and a substantially trapezoidal shape so that the thickness of the rubber material is reduced at both side portions in a width direction which constitute overlapping margins.

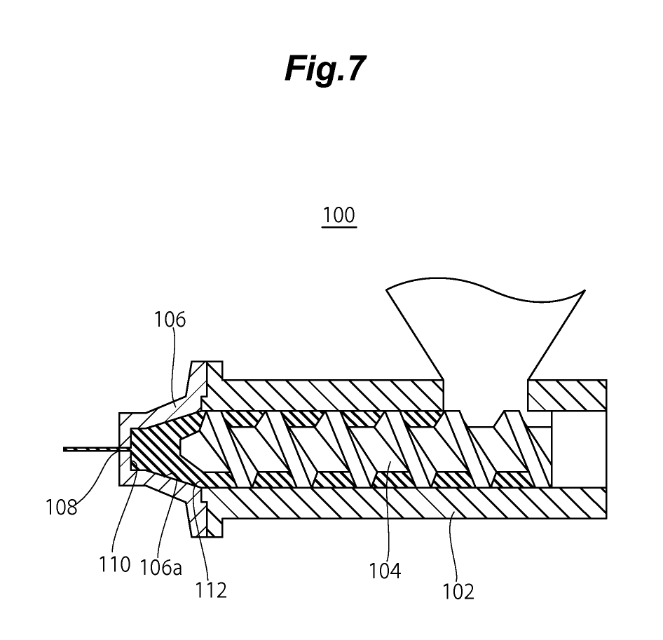

A rubber strip material like this is formed as is shown in FIG. 7. That is, a discharge port 108 which is provided at a distal end portion of an inner hole portion 106a of an extruding die 106 provided on a main body case 102 of an extrusion apparatus 100 is formed into, for example, a flat substantially crescent shape or substantially triangular shape, then, a rubber material is fed by a feeding screw shaft 104 from the main body case 102 of the extrusion apparatus 100 into a inner hole portion 106a of the extruding die 106 provided on the main body case 102, and the rubber material so fed is then extruded from the discharge port 108.

In the extruding die 106 used in the extruding operation, a drawing stepped surface 110 is provided at the distal end portion of the inner hole portion 106a, and the discharge port 108 is provided in a central portion of the stepped surface 110. The inner hole portion 106a is formed in a taper shape which tapers away from a rear end portion opening 112 which connects to the main body case 102 of the extrusion apparatus 100 towards the drawing stepped surface 110.

In the extrusion apparatus 100 configured as described above, however, the rubber material which is fed into the extruding die 106 by the screw shaft 104 is pressurized to increase its pressure by virtue of the drawing effect by the drawing stepped surface 110 and is then extruded from the discharge port 108. As this occurs, since a large frictional force is produced between the rubber material being extruded and the inner hole portion 106a for application to the rubber material, the cross-sectional shape of the rubber strip material so extruded is made difficult to be stabilized. In addition to this, there is caused a problem that a scorching occurs in which an unvulcanized rubber material within the extruding die is subjected to premature vulcanization by the frictional heat. A vulcanized rubber produced by the scorching sticks to an interior of the extruding die 106 or the discharge port 108 to thereby deteriorate further the flow of material rubber, inducing a failure in shaping the cross-sectional shape of the rubber strip material.

In addition, although the extruded rubber strip material is preferably thin in thickness at both the side portions in the width direction in view of the fact that the extruded rubber strip material is wound in a partially overlapping fashion, the pressure becomes larger at both the side portions than at the central portion of the discharge port 108, and there is caused a problem that as the thickness of the resultant rubber strip material becomes thinner at both the side portions in the width direction, cracking and missing such as chipping become easier to occur thereat.

To cope with this problem, the cross-sectional shape of the rubber strip material can be stabilized by reducing the extrusion speed of the rubber material, but this calls for an increase in extrusion cycle time in fabrication of tires, leading to a problem that the productivity thereof is reduced.

Patent Document No. 1: JP-A-2005-238799

### DISCLOSURE OF THE INVENTION

### Problem that the Invention is to Solve

The invention has been made in view of the problems and an object thereof is to provide a rubber strip material extrusion apparatus and extrusion method for extruding stably a rubber strip material of a predetermined cross-sectional shape without reducing the extrusion speed of the rubber strip material from an extruding die.

### Means for Solving the Problem

The invention provides an extrusion apparatus for a rubber strip material for use in a tire fabrication process in which an unvulcanized rubber strip material which is extruded from an extruding die is wound spirally to build a tire rubber member, characterized in that a pair of rotatable rolls are provided at a distal end portion of the extruding die in such a manner that their outer circumferential surfaces confront each other, and in that an extruding discharge port is formed in a gap defined by the pair of confronting rolls.

In this way, since the discharge port is formed in the gap defined by the pair of rotatable rolls which confront each other and the rubber strip material can be extruded from the extruding discharge port while causing the pair of rolls to rotate individually in a direction in which the rubber strip material is fed to the outside, a pressure in an interior of the extruding die which is necessary to extrude the rubber strip material is set small so as to increase the extruding speed of the rubber strip material. In addition, since the frictional force between the rubber material and the rollers can be made extremely small at the discharge port which shapes an external shape of the rubber strip material, even when a rubber strip material whose thickness at both side portions in the width direction is thin is extruded, neither cracking nor missing such as chipping is produced at both the side portion in the width direction.

Moreover, since the pressure in the interior of the extruding die is set small and the generation of frictional heat can be suppressed by suppressing the frictional force between the rubber material and the rollers at the discharge port to as low a level as possible, the rubber material in the interior of the extruding die is made difficult to be subjected to premature vulcanization which would otherwise occur due to the rubber material being exposed to high thermal history, whereby the set temperature range of the rubber material can be set wide, thereby making it possible to increase productivity.

In the invention, one roll of the pair of rolls may include a recessed portion at a central portion in the width direction where the outside diameter of the roll is reduced, and the discharge port may be formed between the other roll and the recessed portion, whereby a good extrusion of the rubber strip member is performed.

In addition, in the invention, a shut-off valve such as a gear pump for shutting off the feeding of the rubber material to the discharge port may be provided, whereby although the rubber material staying in the interior of the extrusion apparatus immediately after the extrusion apparatus has been stopped is still left in the pressurized state, the discharge of the rubber material in the interior of the extrusion apparatus from the discharge port can be prevented.

The invention additionally provides an extrusion method for the rubber strip material which is used in a tire fabrication process in which an unvulcanized rubber strip material which is extruded from an extruding die is wound spirally to build a tire rubber member, characterized in that a pair of rotatable rolls are provided at a distal end portion of the extruding die in such a manner that their outer circumferential surfaces confront each other, and in that a rubber material is extruded continuously into a ribbon shape from a gap defined by the pair of confronting rolls.

### Advantage of the Invention

According to the invention, a rubber strip material of a predetermined cross-sectional shape can be extruded stably without reducing an extruding speed of the rubber strip material from the extruding die.

### BEST MODE FOR CARRYING OUT THE INVENTION

Next, an embodiment of the invention will be described in detail based on the drawings.

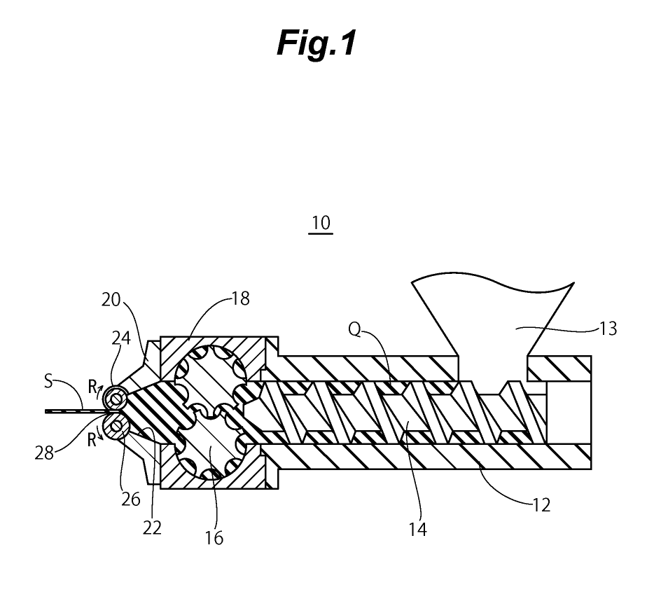

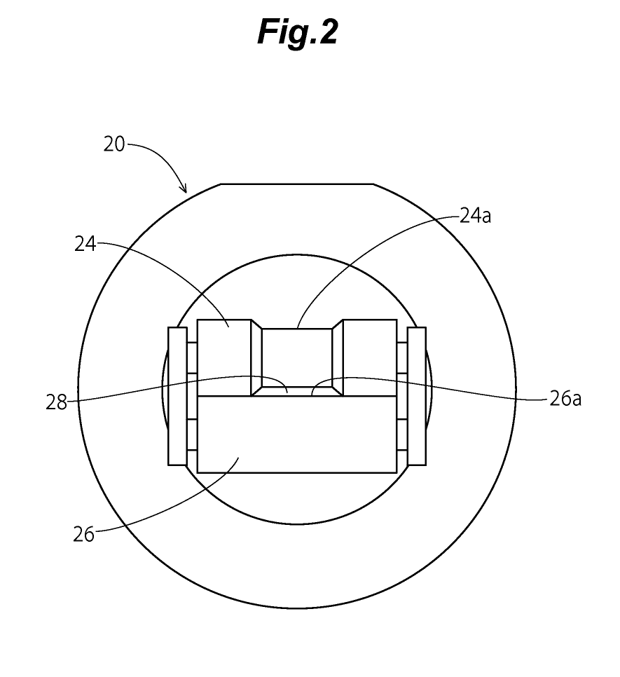

FIG. 1 is a sectional view of an extrusion apparatus 10 according to the invention, and FIG. 2 is a front view showing a die 20 of the extrusion apparatus 10.

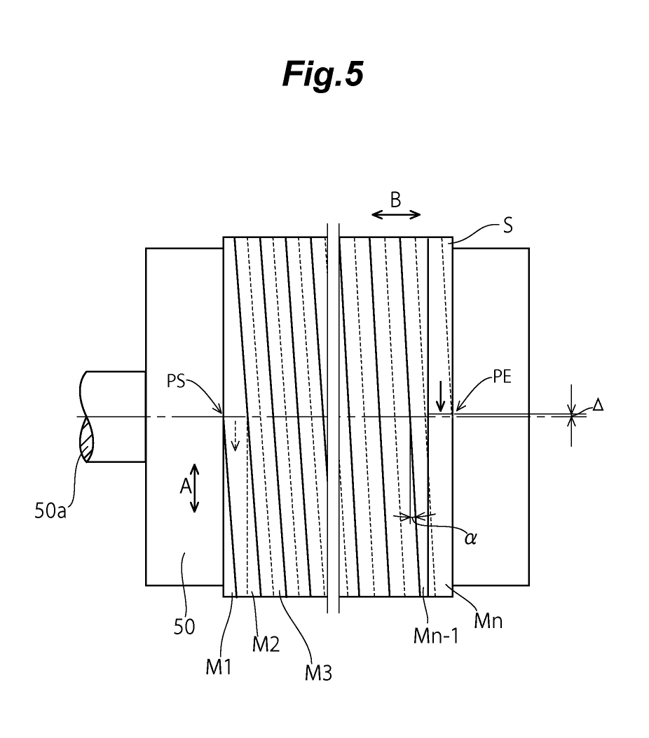

In the invention, a rubber strip material S which constitutes an object to be extruded is formed into a ribbon shape and is used, in a fabrication process of a tire (a radial tire) T shown in FIG. 5, that is, a tire T made up of a plurality of tire rubber members such as an inner liner rubber portion 1, a tread rubber portion 2, side wall rubber portions 3 and rim strip rubber portions 4, for building at least one rubber member of the plurality of rubber members, for example, the inner liner rubber portion 1 or the tread rubber portion 2 through winding.

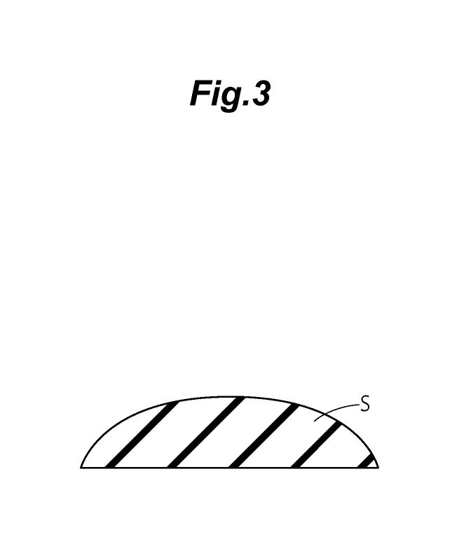

This rubber strip material S is formed into the ribbon shape having a flat cross-sectional shape, for example, a substantially crescent cross-sectional shape as is shown in FIG. 3 in which mainly a central portion in the width direction is made thickest and the thickness is gradually reduced from this central portion towards both side edges.

An extrusion apparatus 10 for extruding the rubber strip material S includes a cylindrical main body case 12 having a circular cross section, a hopper 13 from which a rubber material is supplied into an interior of the main body case 12, a feeding screw shaft 14 provided in the interior of the main body case 12, a head portion 18 having a gear pump 16 and provided consecutively to a distal end portion of the main body case 12 and an extruding die 20 added to a distal end side of the head portion 18.

To describe in detail, the extruding die 20 is such that an inner hole portion 22 constitutes a taper surface which tapers to a distal end thereof and a pair of rolls 24, 26 which are adapted to be rotated by a motor or the like, not shown, are provided at a distal end in such a manner that their outer circumferential surfaces confront each other.

One roll 24 of the pair of rolls 24, 26 has a recessed portion 24a where a diameter of the roll 24 is reduced at a central portion in the width direction, and a discharge port 28 is formed in a gap which is defined by the recessed portion 24a and an outer circumferential surface 26a of the other roll 26 and the pair of rolls 24, 26 which confront each other.

The discharge port 28 is formed to have a substantially crescent shape which corresponds to a cross-sectional shape of the rubber strip S illustrated in FIG. 3 which constitutes an object to be extruded and is provided in such a manner as to extrude a rubber material Q fed into a strip-like shape having a cross section which corresponds to the substantially crescent shape.

In the extrusion apparatus 10, the unvulcanized rubber material Q which is introduced to be supplied into the interior of the main body case 12 from the hopper 13 is fed forwards by virtue of rotation of the screw shaft 14 and is then fed to the extruding die 20 while being adjusted to a predetermined flow rate by the gear pump 16 in the head portion 18.

In the extruding die 20 which receives the rubber material Q so fed thereto, a rubber strip material S having the substantially crescent cross section is continuously extruded from the discharge port 28 which is formed in the gap defined by the pair of confronting rolls 24, 26, whereby the rubber strip material S is formed. As this occurs, the rubber material Q is extruded from the discharge port 28 while rotating the pair of rolls 24, 26 in directions indicated by arrows R in FIG. 1, that is, a direction in which the rubber strip material S is fed to the outside.

In this way, by the rubber strip material S being extruded by rotating the pair of rolls 24, 26 individually, the rubber material Q can be fed to the outside of the extruding die 20 while being shaped into a predetermined cross-sectional shape. Therefore, a pressure in the interior of the extruding die 20 which is necessary to extrude the rubber strip material S can be set small so that the extruding speed of the rubber strip material S can be increased, and the frictional force produced between the rubber material and the rollers at the discharge port where an external shape of the rubber strip material S is shaped can be made as small as possible. Thus, even when a rubber strip material is extruded in which the thickness at both side portions in the width direction is made thin, there is caused no such situation that cracking and missing such as chipping occur at both the side edges in the width direction.

Moreover, since the pressure in the interior of the extruding die can be set small and the generation of friction heat can be suppressed by suppressing the frictional force produced between the rubber material and the rollers at the discharge port to as low a level as possible, the rubber material staying in the interior of the extruding die is made difficult to be subjected to premature vulcanization which would otherwise occur due to the rubber material being exposed to high thermal history, whereby the set temperature range of the rubber material can be set wide, thereby making it possible to increase productivity.

In order to stop the extrusion of the rubber strip material S in the extrusion apparatus 10, the rotation of the screw shaft 14 is stopped, and the gear pump 16 is also stopped so as to shut off a flow path through which the rubber material Q is supplied to the discharge port 28. Although the rubber material Q in a pressurized state remains in an interior of the extrusion apparatus 10 even after the screw shaft 14 has been stopped, since the gear pump 16 shuts off the flow path through which the rubber material Q is supplied to the discharge port 28, it becomes possible to prevent an abrupt discharge of the rubber material Q from the discharge port 28 after the extrusion apparatus 10 has been stopped.

Next, a method will be described for building tire rubber members such as an inner liner rubber portion 1, a tread rubber portion 2, side wall portions 3, and rim strip rubber portions 4 using the extrusion apparatus 10 that is configured as has been described above.

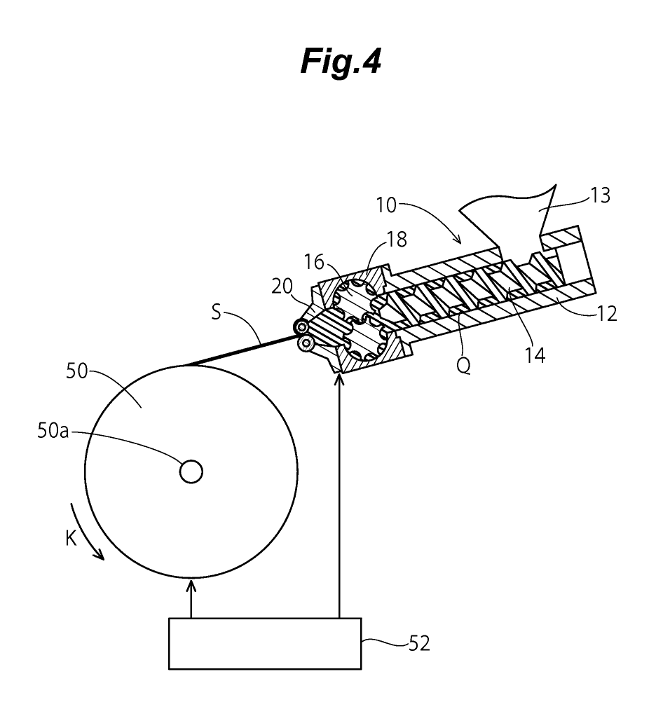

FIG. 4 is an exemplary drawing which explains a method for building a tire rubber member by winding the rubber strip material S which is extruded by the extrusion apparatus 10, and FIG. 5 is a plan view which explains a winding method of the rubber strip material S.

As is illustrated in FIG. 4, the extrusion apparatus 10 is installed in such a manner as to confront a rotational support element 50, so that a rubber strip material S which is extruded into a ribbon shape having a predetermined cross section from the extrusion apparatus 10 is wound directly on to the rotational support element 50. The rotational support element 50 can rotate about a shaft 50a, and the rubber strip material S is wound along a tire circumferential direction while causing the rotational support element 50 to rotate in a direction indicated by reference character K in FIG. 4. Note that the operations of the extrusion apparatus 10 and the rotational support element 50 are controlled by a control unit 52.

Specifically, as is shown in FIG. 5, the rubber strip material S is wound spirally along a tire circumferential direction denoted by an arrow A. When winding the rubber strip material S, not only is the rotational support element 50 caused to rotate, but also the extrusion apparatus 10 is shifted relatively along a tire width direction denoted by an arrow B. Because of this, at least one of the extrusion apparatus 10 and the rotational support element 50 is shifted along the tire width direction.

The rubber strip material S is wound while being shifted from the left to the right. A first lap (a first winding) is denoted by M1, a second lap by M2, a third lap by M3, . . . , an nth−1 lap by Mn−1 and an nth lap (a final lap) by Mn. Here, winding directions of the first lap M1 and the nth lap Mn become the same as a direction which intersects the tire width direction at right angles (which is parallel to the tire circumferential direction). Winding directions of the other winding portions of the rubber strip material 10 are inclined through an angle a relative to the tire circumferential direction because the rubber strip material 10 is wound spirally, and the rubber strip material S is wound in such a manner that adjacent rubber strip materials S, S overlap each other by an amount of, for example, on the order of ½ (one half) to ⅕ of the width of the rubber strip material S.

In the event that the first lap and the final nth lap are also inclined through the angle α, a cutting operation of excess portions will be necessary. However, by the first lap and the final nth lap being caused to be wound in the same direction as the tire circumferential direction, the cutting operation of excess portions is made unnecessary.

By controlling the extrusion apparatus 10 in such a manner as not to be shifted relatively along the tire width direction, the first lap and the final nth lap can be configured as has been described above.

In addition, in FIG. 5, a winding starting position is denoted by PS, and a winding ending position is denoted by PE. In addition, winding is performed in such a manner that a positional offset Δ between the winding starting position PS and the winding ending position PE is in the range of 0 to 5 mm as viewed from the tire circumferential direction, whereby the weight balance of a resultant tire can be maintained good.

### BRIEF DESCRIPTION OF THE DRAWINGS

[FIG. 1] A sectional view of an extrusion apparatus of a rubber strip material according to an embodiment of the invention.

[FIG. 2] A plan view of an extruding die.

[FIG. 3] A sectional view of a rubber strip material.

[FIG. 4] An exemplary drawing which explains a method for extruding a tire rubber member.

[FIG. 5] A plan view of a rotational support element which explains a winding method of the rubber strip material.

[FIG. 6] A sectional view which explains the construction of a tire.

[FIG. 7] A sectional view of a conventional rubber strip material extrusion apparatus.

### DESCRIPTION OF REFERENCE NUMERALS

1 . . . inner liner rubber portion
2 . . . tread rubber portion
3 . . . side wall rubber portion
4 . . . rim strip rubber portion
10 . . . extrusion apparatus
12 . . . main body case
13 . . . hopper
14 . . . screw shaft
16 . . . gear pump
18 . . . head portion
20 . . . extruding die
22 . . . inner hole portion
24, 26 . . . roll
24a . . . recessed portion
28 . . . discharge port
50 . . . rotational support element
50a . . . shaft
52 . . . control unit

1. An extrusion method for the rubber strip material which is used in a tire fabrication process in which an unvulcanized rubber strip material which is extruded from an extruding die of an extruding machine is wound spirally to build a tire rubber member, characterized in that
a pair of rotatable rolls are provided at a distal end portion of the extruding die in such a manner that their outer circumferential surfaces confront each other, and in that
a rubber material is extruded continuously into a ribbon shape from a gap defined by the pair of confronting rolls.
